(19) United States
(12) Patent Application Publication
(10) Pub. No.: US 2024/0020990 A1
(43) Pub. Date: Jan. 18, 2024

(54) METHOD AND SYSTEM FOR DETERMINING A POSITION OF A LANE

(71) Applicant: Continental Autonomous Mobility Germany GmbH, Ingolstadt (DE)

(72) Inventor: Ingrid Tigges, Taunusstein (DE)

(73) Assignee: Continental Autonomous Mobility Germany GmbH, Ingolstadt (DE)

(21) Appl. No.: 18/252,710

(22) PCT Filed: Oct. 7, 2021
(86) PCT No.: PCT/DE2021/200148

§ 371 Date: May 11, 2023

(30) Foreign Application Priority Data
Nov. 13, 2020 (DE) 10 2020 214 327.7

(51) Int. Cl. G06V 20/56; G06V 20/58; G06V 10/24; G06V 10/26; G06V 10/82; G06T 7/70; G06T 7/10

(52) U.S. Cl. CPC G06V 20/588; G06V 20/584; G06V 10/24; G06V 10/26; G06V 10/82; G06T 7/70; G06T 7/10; G06T 2207/20084; G06T 2207/30256

(57) ABSTRACT

A method for determining a position of at least one lane is disclosed The method includes the following: recording at least one image of the surroundings of an ego vehicle by means of a camera of the ego vehicle; evaluating the image of the surroundings by means of an evaluation device; establishing at least one landmark in the image of the surroundings; segmenting the at least one landmark into at least two segments; establishing the alignment of the at least two segments of the at least one landmark; establishing the position of the at least one lane based on the established alignment of at least one of the at least two segments.

### CROSS REFERENCE TO RELATED APPLICATIONS

The present application is a National Stage Application under 35 U.S.C. § 371 of International Patent Application No. PCT/DE2021/200148 filed on Oct. 7, 2021, and claims priority from German Patent Application No. 10 2020 214 327.7 filed on Nov. 13, 2020, in the German Patent and Trademark Office, the disclosures of which are herein incorporated by reference in their entireties.

### TECHNICAL FIELD

The invention relates to a method and a system for determining a position of at least one lane.

### BACKGROUND

Methods and systems which detect roadway markings or roadway boundaries by means of a camera and, thus, establish a lane are, for example, known from the prior art. However, these methods are disadvantageous, for example, in poor weather conditions or visibility conditions or heavy traffic since the lane marking cannot always be recognized then. Thus, the roadway marking can, for example, be concealed wholly or at least partially by snow or similar. Equally, a roadway marking or roadway boundary can be concealed by heavy traffic or parked vehicles. In these cases, the position of a lane cannot be safely determined.

### SUMMARY

It is therefore an object of the present disclosure to provide a method and a system by means of which the position of a roadway can be easily and reliably established.

Initial considerations were that a lane can also be established with the aid of specific landmarks. As a general rule, these landmarks are arranged in such a way that these are at least partially located above a specific lane since the landmark belongs to this lane.

According to the present disclosure, a method for determining a position of at least one lane, including the following steps, is accordingly proposed:
recording at least one image of the surroundings of an ego vehicle by means of a camera of the ego vehicle;
evaluating the image of the surroundings by means of an evaluation device;
establishing at least one landmark in the image of the surroundings;
segmenting the at least one landmark into at least two segments;
establishing the alignment of the at least two segments of the at least one landmark;
establishing the position of the at least one lane based on the established alignment of at least one of the at least two segments.

The camera is preferably a mono camera or stereo camera. Instead of an image of the surroundings, it would also be conceivable to record a series of images or a sequence of images and to evaluate these.

The landmark is established, for example, via an object detection algorithm. The type of landmark can also be determined by the object detection. This can, for example, be realized with the aid of a look-up table or similar. Based on the type of the detected landmark, it can already be concluded whether the landmark is relevant to a potential roadway, since there are specific landmarks which can be assigned to a roadway. These include, for example, traffic lights, road signs, sign gantries or street lamps.

The segmenting of the landmark can be performed, for example, via a segmenting in accordance with homogeneity criteria. In this case, the segments must each fulfil a joint homogeneity criterion. Consequently, all pixels fulfilling this criterion are combined into one segment. A segmenting in accordance with discontinuity criteria would also be conceivable. In the case of this method, the edges are observed or discontinuity criteria are sought at the segment margins.

When the segments have been established, the alignment of the individual segments can also be established. Thus, the angle at which adjacent segments are located with respect to one another in the image of the surroundings can, for example, be established. In addition, it can be established whether a segment is located in a horizontal plane at a specific height in front of the ego vehicle. At least two segments are preferably established. It would also be conceivable for a landmark to include more than two segments, which are then established accordingly by the segmenting.

After the alignment of the segments has been established, the position of a lane can be established if, for example, one segment is arranged vertically and a further segment is arranged horizontally in the image and the horizontal segment substantially extends in the direction of the ego vehicle or the center of the image. Consequently, it can be stipulated that such a landmark is located above a lane. In this way, the position of the lane can be determined particularly advantageously.

In a particular embodiment, the landmark is a street lamp. As a general rule, street lamps have a vertical and a horizontal component. Furthermore, object recognition algorithms can, for example, conclude that the object is a street lamp by virtue of the form, colors and arrangement, or can identify the recognized object having the corresponding features as being a street lamp on the basis of a look-up table. Street lamps are particularly advantageous, since these are arranged at regular intervals along the street in a town. By contrast, other landmarks such as traffic lights are only arranged at specific points, for example intersections. It would likewise be conceivable to use these landmarks although the use of street lamps is particularly advantageous. Other landmarks could also be utilized as verification or additional information.

Therefore, the street lamp is at least segmented into a lamp post and a lamp head, in a further particular embodiment. The lamp post is arranged vertically and the lamp head is arranged substantially horizontal thereto. In this case, substantially horizontal also includes street lamps which have a curvature between the lamp post and lamp head and the lamp head does not entirely extend in the horizontal direction.

In a further configuration, the position of the lane is established from the alignment of the lamp head. In connection with the type of landmark, that is to say, in this case, a street lamp, the position of the lane can be verified once again since street lamps are, as a general rule, located directly next to a roadway and the lamp head is aligned in such a way that the lane is located at least partially beneath the lamp head. In this way, the position of at least one lane can be advantageously determined. This can be applied not only to the ego lane, but also, for example, alternatively or additionally, to an adjacent lane having the opposite or same direction of travel. Here as well, a landmark, in particular a street lamp, is established in the image, the horizontal segment of which, that is to say the lamp head, is aligned in the direction of the ego vehicle or the center of the image. Here as well, the lane is substantially located at least partially beneath the lamp head.

In a configuration, in order to establish the street lamp, points of light are established in a specific region of the image of the surroundings. In this configuration, bright points of light are sought in a predefinable region of the image or of the images during the evaluation of the image or the sequence of images. The region is, for example, the upper third of the image of the surroundings. The restriction of the region produces a higher probability that detected points of light belong to a street lamp. The bright points of light are preferably the brightest pixels in the image. This procedure can additionally be applied to the regular object recognition in order to verify the object detection.

A neural network is further used for establishing the at least one landmark. In this case, a Convolutional Neural Network (CNN) can be used, for example. A CNN is particularly advantageous, since it can be trained in a supervised way in order to configure the object detection such that it is quicker and more reliable. Thus, the CNN can, for example, be trained in a targeted manner to detect various landmarks.

Furthermore, according to the present disclosure, a system for determining a position of at least one lane is proposed, including a camera for recording an image of the surroundings of a vehicle, an evaluation device for evaluating the image of the surroundings, as well as a computing device for establishing and segmenting a landmark into at least two segments as well as for establishing an alignment of the segments of the landmark and for establishing the position of the at least one lane based on the alignment of at least one of the segments. The computing device can, for example, be a central control unit, ECU, in the vehicle.

In a configuration of the system, the computing device is configured in such a way as to use a neural network for establishing the at least one landmark.

### BRIEF DESCRIPTION OF THE DRAWINGS

Further advantageous configurations and embodiments are set out in the drawings, wherein:

FIG. 1 shows a schematic flow chart of the method according to one embodiment;

FIG. 2 shows a schematic representation of the system according to one embodiment; and

FIG. 3 shows a schematic representation of one embodiment of the present disclosure.

### DETAILED DESCRIPTION

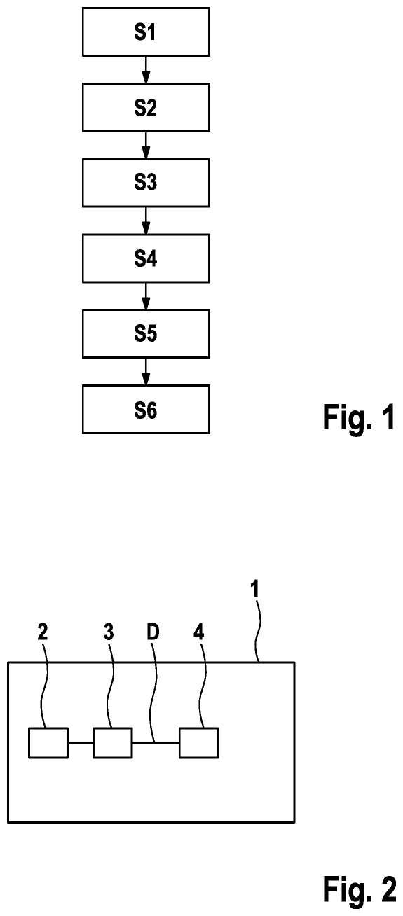

FIG. 1 shows a schematic flow chart of the method according to one embodiment of the present disclosure. The method serves to determine a position of at least one lane. In a first step S1, at least one image of the surroundings of an ego vehicle is recorded by means of a camera of the ego vehicle. In step S2, the image of the surroundings is evaluated by means of an evaluation device. In step S3, at least one landmark is established in the image of the surroundings. In step S4, the at least one landmark is subsequently segmented into at least two segments. In step S5, the alignment of the at least two segments of the at least one landmark is established. In a further step S6, the position of the at least one lane is established based on the established alignment of at least one of the two segments.

FIG. 2 shows a schematic representation of the system 1 according to one embodiment of the invention. The system 1 includes a camera 2, an evaluation device 3 as well as a computing device 4. These elements are connected to one another by means of a data connection D. The data connection D can be configured to be wired or wireless, for example as Bluetooth, WLAN or similar.

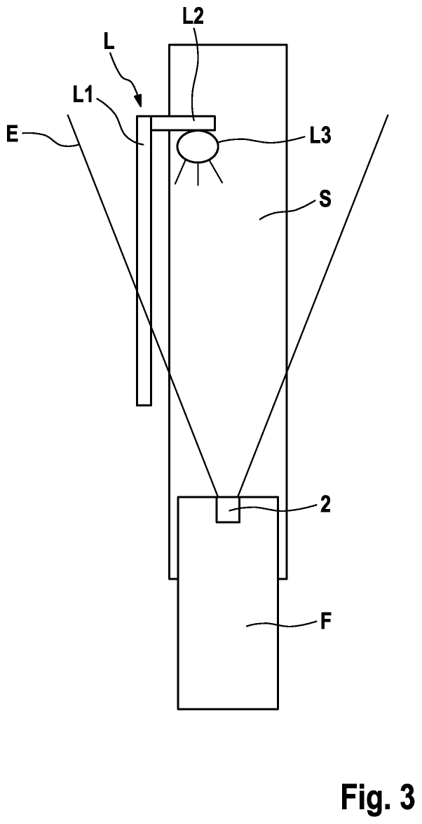

FIG. 3 shows a schematic representation of one embodiment of the present disclosure. In this representation, a driving situation is shown, in which an ego vehicle F detects a landmark L by means of a camera 2. The landmark L is located in the capturing region E of the camera 2 of the ego vehicle F. The landmark L includes the segments L1, L2 and L3. In this configuration, L1 is the lamp post, L2 is the lamp head and L3 is the means of lighting. Depending on the configuration of the landmark or, in this case, of the street lamp, the means of lighting L3 can also be integrated into the lamp head L2 in such a way that the lamp head, together with the means of lighting, form a joint segment L2. In this case, the street lamp has one vertical segment L1, the lamp post, and, in this representation, two horizontal segments L2, L3. In particular, the segment L2, the lamp head, extends in the direction of the ego vehicle F or in the direction of the center of the image. Usually, street lamps are arranged in such a way that the means of lighting at least partially illuminates the lane S. Therefore, the position of the lane S can be concluded thanks to the position of the segments L2, L3. As can be seen in this representation, the lane S is located at least partially beneath the segments L2, L3, that is to say beneath the lamp head or the means of lighting. In this way, the position of the lane S can, consequently, be determined particularly easily and reliably.

### LIST OF REFERENCE NUMERALS

1 System
2 Camera
3 Evaluation device
4 Computing device
D Data connection
E Capturing region
F Ego vehicle
L Landmark
L1-L3 Segments
S Lane
S1-S6 Method steps

1. A method for determining a position of at least one lane, comprising:
recording at least one image of the surroundings of an ego vehicle by a camera of the ego vehicle;
evaluating the image of the surroundings by an evaluation device establishing at least one landmark in the image of the surroundings;
segmenting the at least one landmark into at least two segments;
establishing an alignment of the at least two segments of the at least one landmark; and
establishing a position of the at least one lane based on the established alignment of at least one of the at least two segments.

2. The method according to claim 1, wherein the landmark is a street lamp.

3. The method according to claim 2, wherein the street lamp is segmented at least into a lamp post and a lamp head.

4. The method according to claim 3, wherein the position of the at least one lane is established based on the alignment of the lamp head.

5. The method according to claim 2, wherein establishing the street lamp comprises establishing points of light in a specific region of the image of the surroundings.

6. The method according to claim 1, wherein a neural network is used for establishing the at least one landmark.

7. A system for determining a position of at least one lane, comprising:
a camera for recording an image of the surroundings of a vehicle,
an evaluation device for configured to evaluate the image of the surroundings,
a computing device configured to establish and segment a landmark into at least two segments, to establish an alignment of the segments of the landmark, and to establishing a position of the at least one lane based on the alignment of at least one of the segments.

8. The system according to claim 7, wherein the computing device is configured in such a way as to use a neural network for establishing the at least one landmark.

9. The system according to claim 7, wherein the landmark is a street lamp.

10. The system according to claim 9, wherein the street lamp is segmented at least into a lamp post and a lamp head.

11. The system according to claim 10, wherein the position of the at least one lane is established based on the alignment of the lamp head.

12. The system according to claim 9, wherein establishing the street lamp comprises establishing points of light in a specific region of the image of the surroundings.
